(19) United States
(12) Patent Application Publication
(10) Pub. No.: US 2025/0237736 A1
(43) Pub. Date: Jul. 24, 2025

(54) RADAR SYSTEM FOR VEHICLE WITH OFFSET ELECTRONICS

(71) Applicant: OPmobility SE, LYON (FR)

(72) Inventors: Mathieu BANCELIN, Sainte-Julie (FR); Laurent ROCHEBLAVE, Sainte-Julie (FR); Frédéric STABLO, Sainte-Julie (FR)

(73) Assignee: OPmobility SE, LYON (FR)

(21) Appl. No.: 18/687,127

(22) PCT Filed: Sep. 2, 2022
(86) PCT No.: PCT/EP2022/074488

§ 371 Date: Jan. 28, 2025

(30) Foreign Application Priority Data
Sep. 3, 2021 (FR) FR2109251

(51) Int. Cl. G01S 7/03; G01S 13/931

(52) U.S. Cl. CPC G01S 7/03; G01S 13/931; G01S 2013/93275

(57) ABSTRACT

A radar system for a motor vehicle includes at least one directional antenna comprising a housing comprising an inner space forming a reflecting cavity for electromagnetic waves, the inner space having a metasurface configured to transmit electromagnetic waves with a first direction; an electronic unit located outside and at a distance from the housing, comprising a primary emitter and a primary receiver of electromagnetic waves; and at least one waveguide for propagating electromagnetic waves between the primary emitter and the cavity and between the cavity and the primary receiver.

The present disclosure relates to the field of motor vehicles such as automobiles equipped with a radar system for emitting and/or receiving an electromagnetic wave in a desired direction, in particular for detecting an obstacle.

Automobiles are known that are equipped with radar type devices, generally positioned on the front and rear bumpers of the vehicle. These radar devices are used for parking assistance as well as for driving assistance, for example for applications for regulating the speed of vehicles depending on traffic, better known as Adaptive Cruise Control (ACC) in which the radar device detects the speed and distance of a vehicle preceding the vehicle carrying the radar device. Such a radar is used in particular to regulate the speed of vehicles in accordance with traffic and/or obstacles on the road. The radar detects the speed and distance of the object preceding the carrier vehicle, so as to maintain a safe distance between vehicles.

Generally speaking, an important field of radar applications in the automotive industry is that of vehicle bodies in which more and more radar modules are integrated to allow total peripheral detection around the vehicle, for example for equipment such as parking assistance systems, backup assistance systems or pedestrian protection systems or other systems of this type. However, these different radars are of different types depending on their field of detection (long or short distance, frontal or lateral detection, etc.) and their function (parking, autonomous driving, etc.) but also depending on their manufacturer; this does not allow them to be able to optimally consolidate the data provided by each person independent of the various vehicle equipment which can use them (braking, steering, headlights, audible or visual alarms, etc.).

Thus, in order to better characterize the peripheral environment of the vehicle, automobile manufacturers need devices making it possible to improve, on the one hand, the size of the space to be monitored around the vehicle, and on the other hand, the resolution of the processing of the information from these devices. This is so that the vehicle interacts as well as possible, that is to say with more precision and more quickly, with its environment, in particular to avoid accidents, to facilitate maneuvers and to drive autonomously.

In order to increase peripheral space (3D) detection around the vehicle, automobile manufacturers are required to increase the number of radars distributed over a given surface area.

However, increasing the number of radars used leads to an increase in cost.

In addition, the increase in the number of radars requires continuous powering of numerous radio frequency paths; this consumes a lot of energy and is very detrimental, in particular for autonomous and/or electric vehicles.

Furthermore, even if the radars can be miniaturized a bit, increasing the number of radars distributed over a given surface area can be difficult to achieve due to the limited available surface area (the size of the bodywork parts cannot be increased) as well as the presence of other equipment, especially since it may be necessary to maintain a minimum distance between each radar to prevent them from interfering with one another.

To obtain additional information relating to the position and speed of an obstacle given by radars, devices are sought that have in particular an increased spatial resolution making it possible, for example, to recognize objects (environment or obstacles) surrounding the vehicle, to follow their trajectory, and to create the most complete imagery possible.

Thus, vehicles are increasingly equipped with devices complementary to radars, such as LIDAR and cameras.

Spatial resolution expresses the ability of an observation device to distinguish details. It can be characterized in particular by the minimum distance that must separate two contiguous points in order for them to be correctly discerned.

In the case of radar, this resolution distance depends on the ratio between the wavelength of the wave used for observation, and the size of the aperture of the observation device. Thus, to improve the spatial resolution, that is to say reduce the resolution distance, it is necessary to decrease the wavelength (increase the frequency of the wave) and/or to increase the aperture of the observation device. Indeed, the spatial resolution R is characterized by the following equation:

$$R = \frac{c * L}{f * O}$$

where c is the speed of light, L the distance between the observation device and the target, f the frequency of the radar and O the aperture of the observation device.

This is why we are today seeking to use radars operating at higher frequencies, for example at 77 GHz instead of 24 GHz.

On the other hand, the miniaturization of current radars leads to reducing their aperture and therefore their resolution.

Furthermore, a problem encountered for a radar mounted on a bodywork part concerns the positioning of the radar. Indeed, it is important to be able to ensure the integrity of a radar so that it fulfills its function correctly, even in the event of deformation of the bodywork part supporting it (impact, thermal expansion, etc.). It is therefore necessary to ensure good positioning of the radar (direction of emission/reception maintained) throughout the duration of use of the radar function.

It is therefore necessary to provide a solution making it possible to provide the position and speed of objects located around the vehicle and to obtain a more suitable range and spatial resolution, while limiting the cost and energy consumption of the detection device. This makes it possible to improve the detection of objects or people around the vehicle and to facilitate the installation of such systems in self-driving vehicles, in particular electric vehicles whose consumption must be limited as much as possible.

Furthermore, irrespective of the type of radar carried by a bodywork part, a problem encountered concerns vulnerability of electronic components to impacts. Indeed, during an impact deforming the wall carrying the radar, there is a risk of damage to the components, such as the electronic unit carrying in particular the emitter-receiver of the radar wave and its control electronics, rendering the radar function unfit. However, replacing these components is expensive.

The present disclosure aims in particular to remedy these drawbacks by providing a radar system comprising an electronic unit and a directional antenna, the electronic unit being separated from the directional antenna, in order to be able to be offset in a zone of the vehicle less subjected to impact than the zone carrying the directional antenna.

To this end, the present disclosure relates to a radar system for a motor vehicle comprising:
at least one directional antenna comprising a housing comprising an inner space forming a reflecting cavity for electromagnetic waves, the inner space having a metasurface configured to transmit electromagnetic waves with a preferred direction;
an electronic unit located outside and at a distance from the housing, comprising a primary emitter and a primary receiver of electromagnetic waves; and
at least one waveguide for propagating electromagnetic waves between the primary emitter and the cavity and between the cavity and the primary receiver.

Due to the separation between the electronic unit and the directional antenna on the one hand, and to the configuration allowing the electronic unit to be offset from the directional antenna on the other hand, it is thus possible to position the directional antenna in a zone of the vehicle enabling the vehicle's environment to be correctly imaged, while positioning the electronic unit in a zone less subject to impact.

In a manner known to specialists, a zone less subject to impacts is a zone which depends on the bodywork part on which the radar system is installed. For example, for a bumper, a zone less subject to impacts can be a zone set back from the exterior skin, and/or a zone offset laterally (towards the fenders) relative to the vehicle and/or a zone offset vertically (for example lower than the directional antenna). More precisely, during an impact, the deformations causing damage to a vehicle are measured from the exterior face of the bumper and along a longitudinal dimension called intrusion. These intrusions depend on the mass of the vehicle or the impactor which hits it according to the protocol and its speed. The zone less subject to impacts can be defined according to the intrusion.

According to other optional features of the radar system, taken either alone or in combination:
the electronic unit comprises electronics for controlling the primary emitters and receivers, and electronics for controlling the metasurface.
the waveguide is mounted fixedly on the housing and removably on the electronic unit, or the waveguide is mounted fixedly on the electronic unit and removably on the housing.
the radar system comprises:
   a first waveguide for propagating electromagnetic waves between the primary emitter and the cavity; and
   a second waveguide for propagating electromagnetic waves between the cavity and the primary receiver.
The radar system comprises:
   at least a first directional antenna forming an emitter element including a housing forming a cavity provided with a metasurface configured to reflect electromagnetic waves coming from a first waveguide in a preferred direction (e.g., first direction) towards the exterior of the housing;
   at least one second directional antenna forming a receiving element including a housing forming a cavity provided with a metasurface configured to reflect electromagnetic waves in a preferred direction (e.g., a second direction) towards the second waveguide.
the electronic unit is configured to operate at frequencies above 60 GHz, in particular between 75 and 80 GHz, preferably at 77 GHz.

The present disclosure also relates to a bodywork part, comprising a radar system according to the disclosure, the housing being attached to a first zone of the bodywork part, and the electronic unit being attached to a second zone of the bodywork part.

According to other optional features of the bodywork part, taken alone or in combination:
the second zone is a zone less exposed to impacts than the first zone in the event of an impact on the bodywork part, and preferably in a zone outside the impact intrusion space.
the second zone is located on a structural element, such as a beam or a spar.
the second zone is a laterally offset zone and/or a vertically offset zone relative to the first zone, and/or a zone further back than the first zone.
the housing is attached to a first zone of the bodywork part, and the electronic unit is attached to a damping, deformable or shear member at the second zone of the bodywork part.
the housing and the electronic unit are at a distance of between 5 cm and 20 cm.

The present disclosure also relates to a set of vehicle parts comprising a radar system according to the disclosure, and the housing is attached to a first bodywork part, and the electronic unit is attached to a second part, the second part being less exposed to impacts than the first part in the event of an impact on the first bodywork part, and preferably in a part outside the impact intrusion space.

According to other optional features of the assembly, taken alone or in combination:
the second part is located behind a structural element, or constitutes a structural part.
the second part is chosen from the following parts:
   tiebar reinforcement, air intake grille, lower convergence, shock frame, absorber, radiator air guide;
   front end, for example on an upper crossmember or other part of the frame, fender support, front trunk.
the assembly comprises a part carrying the electronic unit, and at least two other parts each carrying at least one housing connected to the electronic unit.

The present disclosure also relates to a motor vehicle comprising a radar system according to the disclosure, as well as a motor vehicle comprising a bodywork part according to the disclosure, and a motor vehicle comprising a set of vehicle parts according to the disclosure.

### BRIEF DESCRIPTION OF THE FIGURES

The various disclosed embodiments will be better understood upon reading the following description, which is provided merely as example and with reference to the appended drawings, wherein:

FIG. 1 shows an example of a motor vehicle equipped with an example of a radar system according to an embodiment.

FIG. 2 shows in detail an example of a radar system according to an embodiment.

FIG. 3 shows an example in which the radar system comprises a first waveguide for propagating electromagnetic waves between the primary emitter and the cavity, and a second waveguide for propagating electromagnetic waves between the cavity and the primary receiver.

FIG. 4 shows an example in which the radar system comprises a first directional antenna, called “emitting antenna”, and a second directional antenna, called “receiving antenna”.

FIG. 5 shows an example of a bodywork part comprising a radar system according to an embodiment.

FIG. 6 schematically shows, in cross-section and top view, an example of a bodywork part (left half of a bumper) comprising a radar system according to an embodiment, in which the electronic unit is attached to the same bodywork part as the housing, by means of an impact-absorbing, deformable or fusible member.

FIG. 7 schematically shows, in cross-section and top view, an example of a bodywork part (left half of a bumper) comprising a radar system according to an embodiment, in which the electronic unit is attached to the same bodywork part as the housing, but in a zone offset laterally relative to the housing attachment zone.

FIG. 8 schematically shows, in cross-section and top view, an example of a bodywork part (left half of a bumper) comprising a radar system according to an embodiment, in which the electronic unit is attached to the same bodywork part as the housing, but on a portion of the bodywork part located farther back (towards the rear) relative to the attachment zone of the housing.

FIG. 9 shows an example of a bodywork part comprising a radar system according to an embodiment, in which the housing is attached to a first part, a bodywork part (for example a bumper), and the electronic unit is attached to a second part (different bodywork part, structural part, optical unit, etc.).

### DETAILED DESCRIPTION

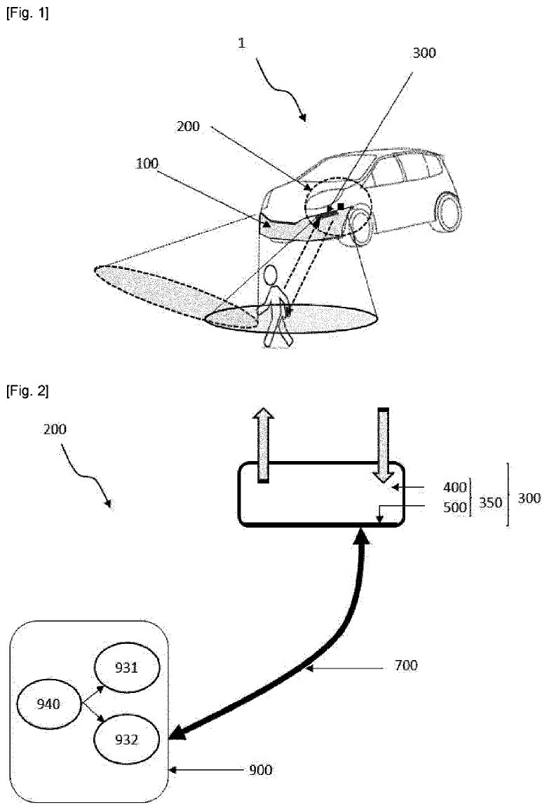

We refer to FIG. 1 which shows an example of a motor vehicle 1 equipped with an example of a radar system 200 according to an embodiment, with at least one directional antenna 300.

FIG. 2 shows in detail an example of a radar system 200 for a motor vehicle 1 according to an embodiment.

The radar system 200 comprises at least:
a directional antenna 300;
an electronic unit 900 located outside and at a distance from the directional antenna 300;
at least one waveguide 700 for propagating electromagnetic waves between the directional antenna 300 and the electronic unit 900.

Waveguide 700 is understood to be a means of guiding waves from one zone to another, in one direction or in both directions. A waveguide 700 can therefore be a waveguide device or a set of waveguide devices.

The directional antenna 300 is adapted to image objects 50 in a space located at the periphery of the vehicle 1 (FIG. 1). The directional antenna 300 includes a housing 350, which constitutes the physical envelope of the directional antenna 300. The housing 350 represents a mechanical and environmental protection envelope, and advantageously comprises means for attachment to a wall of a bodywork part.

This housing 350 comprises an inner space forming a reflecting cavity 400 for electromagnetic waves. A reflecting cavity is an electromagnetic cavity 400 in which an electromagnetic wave is reflected off the walls of the cavity. To do this, the reflecting cavity 400 is delimited by a layer of reflective material capable of reflecting electromagnetic waves inside the cavity 400.

The inner space of the housing 350 comprises a metasurface 500, comprising an adaptable surface configured to reflect electromagnetic waves in a preferred direction. The reflecting cavity thus surrounds the metasurface 500 in a manner sealed to waves.

Note that the radar system 200 may include several waveguides, in particular a waveguide for emitting and a waveguide for receiving electromagnetic waves.

The radar system 200 also comprises an electronic unit 900 located outside and at a distance from the housing 350. By “at a distance” is understood to mean at a distance allowing positioning of the electronic unit 900 in a zone of less impact than the directional antenna 20.

During an impact, the deformations causing damage to a vehicle are measured from the exterior face of the bumper and along a longitudinal dimension called intrusion. These intrusions depend on the vehicles and can be evaluated by simulation calculations or physical tests with an impactor and well-defined impact conditions, notably in terms of mass, speed and direction.

The electronic unit is said to be positioned in a zone subject to impact when it is located inside the intrusion space, that is to say at a distance from the exterior face of the bumper less than the intrusion dimension. To position the electronic unit in a zone less subject to impacts, for example in the case of a front bumper, it is positioned above a horizontal plane passing through the highest point of the impact beam and its absorber or below a horizontal plane passing through the lowest point of the impact beam and its absorber.

Preferentially, in the case of a front bumper, the electronic unit is positioned beyond the intrusion space, that is to say generally beyond 50 mm behind the bumper skin for light vehicles and beyond 100 mm for heavier vehicles to preserve it in the event of a parking impact at 4 km/h (governed by ECE42). In order to preserve this electronic unit in the event of an impact at 16 km/h (otherwise called repairability impact) it can be positioned 200 mm back from the bumper skin and behind the rear plates of the impact beam.

The electronic unit 900 comprises a primary emitter 931 and a primary receiver 932 of electromagnetic waves. Preferably, the electronic unit also includes control electronics 940 of the primary emitters 931 and receivers 932, control electronics of the metasurface 500, waveguide connectors, connectors making it possible to connect the control electronics of the metasurface 500 and the metasurface 500, a power supply and a housing forming an environmentally sealed envelope (water, dust, etc.) of the electronic elements.

The electronic unit 900 is configured to operate at frequencies above 60 GHz. According to one embodiment, the electronic unit 900 is configured to operate at frequencies between 75 and 80 GHZ, preferably at 77 GHZ. According to another embodiment, the electronic unit 900 is configured to operate at frequencies between 120-160 GHZ, preferably at 140 GHz.

Finally, the radar system 200 also includes at least one waveguide 700 for propagating electromagnetic waves between the primary emitter 931 and the cavity 400 and between the cavity 400 and the primary receiver 932.

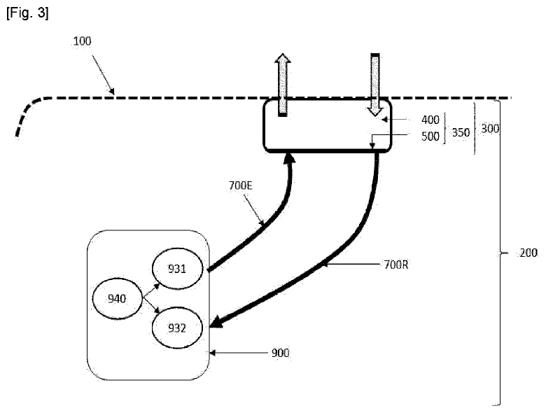

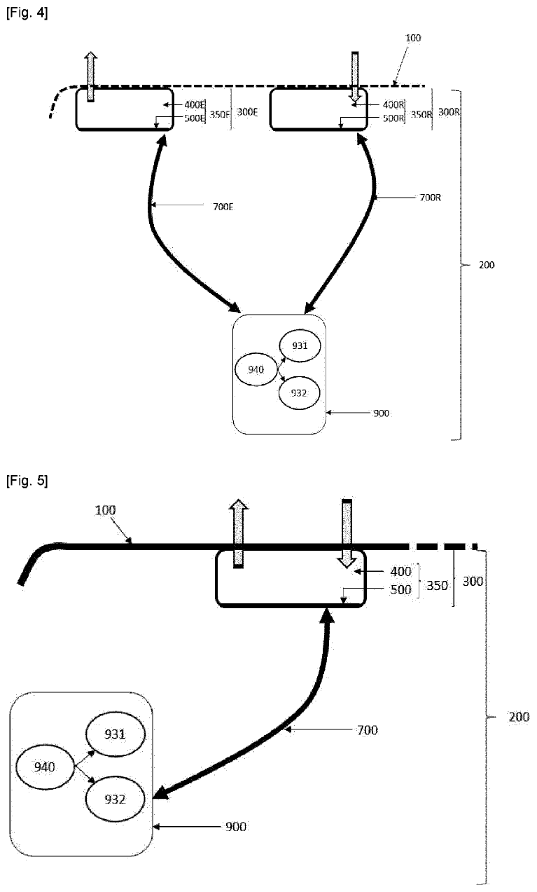

In FIG. 3, the radar system 200 comprises a first waveguide 700E for propagating electromagnetic waves between the primary emitter 931 and the cavity 400, and a second waveguide 700R for propagating electromagnetic waves between the cavity 400 and the primary receiver 932.

In FIG. 4, the radar system 200 comprises:
a first directional antenna 300E, called “emitting antenna”, forming an emitting element including a housing 350E forming a cavity 400E provided with a metasurface 500E configured for emitting electromagnetic waves coming from a first waveguide (700E) in a preferred direction towards the outside of the housing 350E (towards the outside or the periphery of the vehicle);
a second directional antenna 300R, called “receiving antenna”, forming a receiving element including a housing 350R forming a cavity 400R provided with a metasurface 500R configured for receiving returning electromagnetic waves (from the outside or the periphery of the vehicle, after reflection from an obstacle) in a preferred direction towards the second waveguide 700R.

According to this embodiment, the first waveguide 700E propagates electromagnetic waves between the primary emitter 931 and the cavity 400E of the first directional antenna 300E, and the second waveguide 700R propagates electromagnetic waves between the cavity 400R of the second directional antenna 300R and the primary receiver 932.

### The Waveguide 700

According to one embodiment, the waveguide 700 is mounted fixedly on the housing 350 and removably on the electronic unit 900.

According to another embodiment, the waveguide is mounted fixedly on the electronic unit 900 and removably on the housing 350. The waveguide is thus mounted already connected to the antennas integrated into the bodywork part, the other end to be connected to the offset housing 350.

According to another embodiment, the waveguide is mounted removably on the electronic unit 900 and removably on the housing 350.

Advantageously, the waveguide 700 comprises removable connectors, so as to be connectable to the antenna housing and/or to the electronic unit, and to be disconnectable from the antenna housing and/or from the electronic unit. This facilitates general assembly and even more so mounting on remote parts, but also the repairability of the radar system 200.

The connection can be made on the external surface (surface opposite the reflecting cavity 400) of the housing 350 or through the wall of the reflecting cavity 400. According to this last variant, the connection can be made to the connector of the metasurface 500. In this case, and according to an advantageous embodiment, the waveguide 700 is combined with an electric control wire to control the metasurface 500, forming a beam. The electric wire makes the connection between the metasurface 500 and the control electronics of the metasurface 500. Thus, when mounting (and connecting connectors) on a vehicle, only one operation is needed to mount the waveguide and the control wire. According to a variant, each end of the waveguide and the control wire are connected to the same connector, thus allowing simultaneous connection of the waveguide 700 and the control wire.

Advantageously, the waveguide 700 is attached/held on the internal face of the wall (body panel) of the bodywork part on which the housing 350 is installed, in order to avoid movements and vibrations of the waveguide 700, and in order to avoid mechanical stress on the connectors.

The waveguide can be rigid, but according to a preferential embodiment the waveguide is flexible, allowing easier assembly on a vehicle, because the waveguide can then be slipped into different corners and follow the curve of the parts. In addition, a flexible waveguide increases impact robustness during impacts.

### The Metasurface 500

The metasurface comprises an adaptable surface capable of reflecting in a given direction (and in a controlled manner) the electromagnetic wave emitted by the waveguide 700E in the cavity, and reciprocally capable of reflecting the electromagnetic wave coming from outside the housing 350 to the waveguide 700R. Such a metasurface is described for example in the following document: FR 3093961.

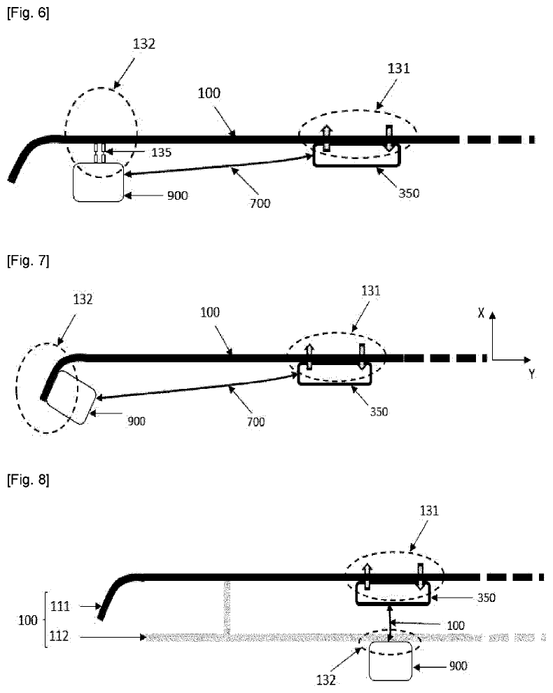

The present disclosure also relates to a bodywork part 100 (FIG. 6) comprising a radar system 200 according to an embodiment. As shown in FIG. 6, the housing 350 is attached to a first zone 131 of the bodywork part 100, and the electronic unit 900 is attached to a second zone 132 of the bodywork part 100.

This installation on the same bodywork part makes it possible to integrate the complete radar system 200 on a single part.

The first zone 131, carrying the directional antenna 300, must be located as close as possible to the visible surface of the part mounted on a vehicle, so that there is the least amount of material between the directional antenna and the space to be imaged, for reasons of good transmission of electromagnetic waves. For example, when the bodywork part is a plastic bumper, the directional antenna should be placed just behind the skin. This type of zone is therefore by nature exposed to impacts.

In addition, the first zone 131, carrying the directional antenna 300, must be located opposite the zone to be imaged by the radar system 200. This type of zone is also by nature exposed to impacts.

According to a first embodiment, the electronic unit 900 is attached to a damping, deformable or shear member 135 (see FIG. 6) at the second zone 132 of the bodywork part 100. For example, the electronic unit 900 can be mounted on legs with programmed deformation and breakage in the event of impact. Thus, in the event of an impact on the bodywork part 100, the shear member absorbs part of the impact and breaks, avoiding transmitting forces to the electronic unit 900.

According to a second embodiment, in order to protect the electronic unit 900 in the event of an impact suffered by the bodywork part, the electronic unit 900 is attached to a second zone 132 judiciously chosen so that this zone is less exposed to impacts, that is to say subjected to less force in the event of impacts suffered by the bodywork part 100. Such a zone can be determined by an expert according to the remaining available space (depending on the other components located on the internal face or opposite the internal face of the bodywork part), according to known standards relating in particular to impacts, and according to the manufacturers' specifications. This second zone 132 can thus be:
a zone that is offset, for example vertically relative to the first zone 131, that is to say, lower or higher than the directional antenna 300 once mounted on a vehicle. The offset zone can also be a laterally offset zone (FIG. 7, in which the X axis is the longitudinal axis of the vehicle and the Y axis is the transverse axis), relative to the median plane of the vehicle (commonly called “YO”), relative to the first zone 131. The offset zone may also be a zone offset both laterally and vertically.
a zone further back than the first zone 131 of a visible face of the bodywork part 100. In other words, the zone 132 is further back than the zone 131 relative to the front of vehicle 1 (FIG. 8). For example, when the part 100 is a bumper, the first zone will preferably be located just behind the skin 111 of the bumper (closest to the outside but not visible from the outside when the bumper is mounted on the vehicle), and the second zone 112 will be located at a distance from the internal face.
a zone located on or behind an element of the vehicle, for example an optical unit, or a structural element, such as a beam or a spar, a radiator support (front end), etc.

Thus, the housing 350 and the electronic unit 900 can be positioned at a distance from one another by between 5 cm and 20 cm, or even more than 20 cm.

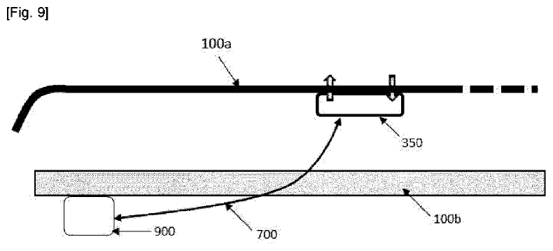

According to one assembly method (FIG. 9), the electronic unit 900 is pre-assembled temporarily on the bodywork part 100 where the housing 350 is attached, which is delivered to the vehicle production line. When the part 100 is mounted on the vehicle, the electronic unit 900 is detached from its delivery position of the part 100, then the electronic unit 900 is moved (with the waveguide already connected, or not, etc.) and attached on the second zone 132 located on the vehicle.

According to an exemplary embodiment, the bodywork part 100 is a front or rear bumper.

The present disclosure also relates to a set of vehicle parts 100a, 100b (FIG. 9), which comprises a radar system 200 according to an embodiment. The housing 350 is attached to a first bodywork part 100a, and the electronic unit 900 is attached to a second part 100b (bodywork part or any other type of part, such as a structural part), the second part 100b being a part less exposed to impacts than the first part 100a, that is to say it is subject to less force in the event of impacts.

This installation on two different parts makes it possible to further protect the electronic unit by judiciously choosing the second part 100b.

The first bodywork part 100a carrying the directional antenna 300 must be located opposite the zone to be imaged by the radar system 200. This part is therefore by nature exposed to impacts.

According to one embodiment, the second part 100b is chosen from the following parts:
tiebar reinforcement, air intake grille, lower convergence, impact frame, absorber, radiator air guide, etc.;
front end (FAT), for example on an upper crossmember or other part of the frame, fender support, front trunk, etc.

According to one embodiment, the set of parts 100a, 100b comprises several parts: one part carries the electronic unit 900, and each other part carries at least one directional antenna 300. This installation thus makes it possible to share the electronic unit with several directional antennas 300.

The present disclosure also relates to a motor vehicle 1 comprising a radar system 200 according to an embodiment, comprising a bodywork part 100 according to an embodiment, or comprising a set of vehicle parts 100a, 100b according to an embodiment.

The present disclosure is not limited to the embodiments presented, and other embodiments will become clearly apparent to the person skilled in the art. In particular, an embodiment has been described with reference to a bumper, but the bodywork part can be any bodywork part such as a side door, a fender, a tailgate, a rear bumper, etc.

What is claimed is:

1. A radar system for a motor vehicle comprising:
at least one directional antenna including a housing comprising an inner space forming a reflecting cavity for electromagnetic waves, wherein the inner space has a metasurface configured to transmit the electromagnetic waves with a first direction;
an electronic unit located outside and at a distance from the housing, comprising a primary emitter and a primary receiver of electromagnetic waves; and
at least one waveguide adapted to propagate the electromagnetic waves between the primary emitter and the reflecting cavity and between the reflecting cavity and the primary receiver.

2. The radar system according to claim 1, wherein the electronic unit further comprises electronics for controlling the primary emitters and the primary receiver, and electronics for controlling the metasurface.

3. The radar system according to claim 1, wherein the at least one waveguide is mounted fixedly on any one of: the housing and removably on the electronic unit and the electronic unit and removably on the housing.

4. The radar system according to claim 1, further comprising:
a first waveguide for propagating electromagnetic waves between the primary emitter and the reflecting cavity; and
a second waveguide for propagating electromagnetic waves between the reflecting cavity and the primary receiver.

5. The radar system according to claim 4, further comprising:
at least a first directional antenna forming an emitter element including an emitting antenna housing forming an emitting antenna reflecting cavity provided with an emitting antenna metasurface configured to reflect electromagnetic waves coming from a first waveguide in the first direction towards the outside of the emitting antenna housing; and
at least a second directional antenna forming a receiving element comprising a receiving antenna housing forming a receiving antenna reflecting cavity provided with a receiving antenna metasurface configured to reflect electromagnetic waves in a second direction towards the second waveguide.

6. The radar system according to claim 1, wherein the electronic unit is configured to operate at frequencies higher than 60 GHz.

7. A bodywork part comprising a radar system, comprising:
at least one directional antenna including a housing comprising an inner space forming a reflecting cavity for electromagnetic waves, wherein the inner space has a metasurface configured to transmit the electromagnetic waves with a first direction;
an electronic unit located outside and at a distance from the housing, comprising a primary emitter and a primary receiver of electromagnetic waves; and
at least one waveguide adapted to propagate the electromagnetic waves between the primary emitter and the reflecting cavity and between the reflecting cavity and the primary receiver;
wherein the housing is attached to a first zone of the bodywork part, and the electronic unit is attached to a second zone of the bodywork part.

8. The bodywork part according to claim 7, wherein the second zone is less exposed to impacts than the first zone in the event of an impact on the bodywork part.

9. The bodywork part according to claim 8, wherein the second zone is located on a structural element.

10. The bodywork part according to claim 7, wherein the second zone is at least one of: a laterally offset zone relative to the first zone, a vertically offset zone relative to the first zone, and a zone further back than the first zone.

11. The bodywork part according to claim 7, wherein the housing is attached to the first zone of the bodywork part, and the electronic unit is attached to a damping, deformable or shear member at the second zone of the bodywork part.

12. The bodywork part according to claim 7, wherein the housing and the electronic unit are at a distance of between 5 cm and 20 cm.

13. A set of motor vehicle bodywork parts comprising a radar system, comprising:
at least one directional antenna including a housing comprising an inner space forming a reflecting cavity for electromagnetic waves, wherein the inner space has a metasurface configured to transmit the electromagnetic waves with a first direction;
an electronic unit located outside and at a distance from the housing, comprising a primary emitter and a primary receiver of electromagnetic waves; and
at least one waveguide adapted to propagate the electromagnetic waves between the primary emitter and the reflecting cavity and between the reflecting cavity and the primary receiver;
wherein the housing is attached to a first bodywork part, and the electronic unit is attached to a second bodywork part, wherein the second bodywork part is less exposed to impacts than the first bodywork part in the event of an impact on the first bodywork part.

14. The assembly according to claim 13, wherein the second bodywork part is located behind a structural element, or constitutes a structural part.

15. The assembly according to claim 13, wherein the second bodywork part is at least one of:
a tiebar reinforcement, an air intake grille, a lower convergence, an impact frame, an absorber, a radiator air guide,
and a front end (FAT), wherein the FAT is on an upper crossmember or on another part of any one of: a frame, a fender support, a front trunk.

16. The assembly according to claim 13, further comprising a part carrying the electronic unit, and at least two other parts each carrying at least one housing connected to the electronic unit.

17. A motor vehicle comprising the radar system according to claim 1.

18. A motor vehicle comprising the bodywork part according to claim 7.

19. A motor vehicle comprising the set of motor vehicle bodywork parts according to claim 13.

20. The radar system according to claim 1, wherein the electronic unit is configured to operate at frequencies between 75 and 80 GHz.

21. The radar system according to claim 1, wherein the electronic unit is configured to operate at a frequency of 77 GHz.

22. The bodywork part according to claim 7, wherein the second zone is in a zone outside an impact intrusion space.

23. The bodywork part according to claim 9, wherein the structural element is any one of: a beam and a spar.
